(19) United States
(12) Patent Application Publication
(10) Pub. No.: US 2012/0028498 A1
(43) Pub. Date: Feb. 2, 2012

(54) CABLE CONNECTOR

(75) Inventors: Moon-sung NA, Yongin-si (KR); Bong-hwan CHO, Suwon-si (KR); Sang-hoon LEE, Suwon-si (KR); Sun-ho YANG, Seoul (KR)

(73) Assignee: SAMSUNG ELECTRONICS CO., LTD., Suwon-si (KR)

(21) Appl. No.: 13/194,338

(22) Filed: Jul. 29, 2011

Related U.S. Application Data
(60) Provisional application No. 61/368,773, filed on Jul. 29, 2010.

(30) Foreign Application Priority Data
Jan. 26, 2011 (KR) 10-2011-0007764

(51) Int. Cl. H01R 3/00; H01R 24/20

(52) U.S. Cl. 439/491; 439/660; 439/488

(57) ABSTRACT

A cable connector for transmitting a signal between first and second electronic devices includes a cable including at least one signal line disposed within a sheath; and a connector disposed at a first end portion of the cable. The connector includes a rotation member connected to the cable; a main body including a rotation member mounting portion to which the rotation member is rotatably connected; and a sub body that has a plug disposed at a first end portion, wherein the sub body is moveably connected to the main body.

### CROSS-REFERENCE TO RELATED PATENT APPLICATION

This application claims the benefit of U.S. Provisional Patent Application No. 61/368,773, filed on Jul. 29, 2010, in the U.S. Patent and Trademark Office, and claims priority from Korean Patent Application No. 10-2011-0007764, filed on Jan. 26, 2011, in the Korean Intellectual Property Office, the disclosures of which are incorporated herein in their entireties by reference.

### BACKGROUND

1. Field

Apparatuses consistent with exemplary embodiments relate to a cable connector, and more particularly, to a cable connector having a flexible shape.

2. Description of the Related Art

A cable connector is a device for electrically connecting two electronic devices to each other. For examples, a cable connector may be a High Definition Multimedia Interface (HDMI) cable connector, a Universal Serial Bus (USB) cable connector, an audio cable connector, a video cable connector, or the like.

Various cable connectors may be used in electronic devices. For example, since a television may be connected to various electronic devices such as a digital versatile disc (DVD) player, a set top box, a speaker, or a computer, a plurality of cable connectors may be used with the television. In this case, due to the number of cable connectors, they may interfere with each other, and it is difficult to arrange the cable connectors. In addition, it is difficult to identify electronic devices that are respectively connected to the cable connectors. Thus, there is a need to develop a cable connector that is easily arranged and identified.

### SUMMARY

According to an aspect of an exemplary embodiment, there is provided a cable connector for transmitting a signal between first and second electronic devices, the cable connector including a cable including at least one signal line disposed within a sheath; and a connector disposed at a first end portion of the cable, wherein the connector includes a rotation member connected to the cable; a main body including a rotation member mounting portion to which the rotation member is rotatably connected; and a sub body including a plug disposed at a first end portion of the sub body, wherein the sub body is moveably connected to the main body.

The sub body may further include a separation blocking projection formed at a second end portion of the sub body, wherein the separation blocking projection prevents the sub body from being separated from the main body.

The main body may include a contact surface which contacts the sub body, and the sub body may include a contact surface which contacts the main body. The cable connector may further include an elastic protrusion formed on a first one of the contact surface of the main body and the contact surface of the sub body; and a plurality of grooves formed on a second one of the contact surface of the main body and the contact surface of the sub body, wherein each of the plurality of grooves may be engageable with the elastic protrusion.

The rotation member may include a contact surface which contacts with the rotation member mounting portion, and the rotation member mounting portion may include a contact surface which contacts with the rotation member. The cable connector may further include an elastic protrusion formed on a first one of the contact surface of the rotation member and the contact surface of the rotation member mounting portion; and a plurality of grooves formed on a second one of the contact surface of the rotation member and the contact surface of the rotation member mounting portion, wherein each of the plurality of grooves may be engageable with the elastic protrusion.

The rotation member may include first and second rotation bosses that are formed on an upper surface and a lower surface, respectively, of the rotation member; a portion of the cable within the rotation member may be divided into first and second internal cables; the first internal cable may extend through a first opening of the first rotation boss, and the second internal cable may extend through a second opening of the second rotation boss.

The main body may include a first internal connector that is electrically connected to the cable, and the sub body may include a second internal connector that is electrically connected to the first internal connector.

The first internal connector may include a plurality of first electrodes, and the second internal connector may include a plurality of second electrodes that are connected to the plurality of first electrodes. A length of each of the plurality of first electrodes or a length of each of the plurality of second electrodes may be equal to or greater than a distance through which the sub body is moveable with respect to the main body.

One of the first and second internal connectors may be a male connector, and the other one of the first and second internal connectors may be a female connector.

The cable connector may further include a mark unit for indicating a use of the cable connector.

The mark unit may include a circular member that is rotatably mounted to one of the main body and the sub body; the circular member may include a plurality of sections; and the connector may include a window formed in the one of the main body and the sub body to which the circular member is rotatably mounted through which one of the plurality of sections of the circular member is visible.

Each of the plurality of sections of the circular member may have a different color or a different character.

The mark unit may include a ring member that is rotatably mounted to one of the main body and the sub body; the ring member may include a mark portion that includes a plurality of sections and a grip portion that is exposed outside the connector, and the connector may include a window formed in the one of the main body and the sub body to which the ring member is rotatably mounted through which one of the plurality of sections of the mark portion is visible.

Each of the plurality of sections of the mark portion may have a different color or a different character.

The cable may include a flexible coil adjacent to the connector.

The flexible coil may be exposed outside the connector, and a diameter of the flexible coil may be equal to a diameter of the sheath of the cable.

The flexible coil may be disposed within the sheath of the cable.

The sub body may be formed of extruded aluminum.

### BRIEF DESCRIPTION OF THE DRAWINGS

The above and other exemplary aspects and/or advantages will become more apparent by describing in detail exemplary embodiments with reference to the attached drawings in which:

FIG. 1 is a schematic perspective view of a cable connector according to an exemplary embodiment;

FIG. 2 is an exploded perspective view of the cable connector of FIG. 1;

FIGS. 3 and 4 are cross-sectional views of the cable connector of FIG. 1.

FIG. 5 is a perspective view of a magnified portion of a rotation member mounting portion of FIG. 2;

FIG. 6 is a partially rear view of a case in which two cable connectors according to an exemplary embodiment are inserted into terminal portions of a television;

FIGS. 7 and 8 are schematic diagrams of first and second internal connectors when a sub body is moved, according to another exemplary embodiment;

FIG. 9 is a schematic diagram of a first internal connector, according to another exemplary embodiment;

FIG. 10 is a cross-sectional view of the first internal connector taken along a line X-X of FIG. 9;

FIG. 11 is a schematic diagram of a second internal connector, according to another exemplary embodiment;

FIG. 12 is a cross-sectional view of a second internal connector taken along a line XII-XII of FIG. 11;

FIG. 13 is a cross-sectional view of a case where a second internal connector is inserted into a first internal connector, according to another exemplary embodiment;

FIG. 14 is a schematic perspective view of a cable connector according to another exemplary embodiment;

FIG. 15 is a set of diagrams of various examples of a circular member, according to exemplary embodiments;

FIG. 16 is a schematic perspective view of a cable connector according to another exemplary embodiment;

FIG. 17 is a schematic perspective view of a ring member of FIG. 16;

FIG. 18 is a schematic diagram of a cable connector according to another exemplary embodiment;

FIG. 19 a schematic diagram of a cable connector according to another exemplary embodiment; and

FIG. 20 is a cross-sectional view of the cable connector taken along a line XX-XX of FIG. 19.

### DETAILED DESCRIPTION

Hereinafter, exemplary embodiments will be described with reference to the attached drawings. Like reference numerals in the drawings denote like elements.

While exemplary embodiments are described herein, they should not be construed as being limited to the specific descriptions set forth herein; rather, these embodiments are provided so that this disclosure will be thorough and complete. In the drawings, the sizes of components are exaggerated for clarity.

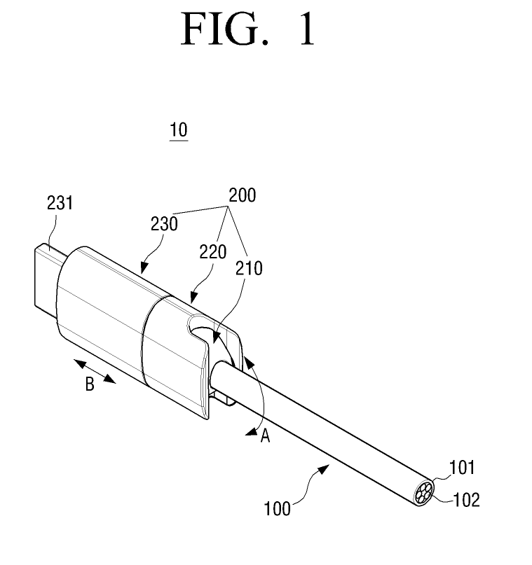

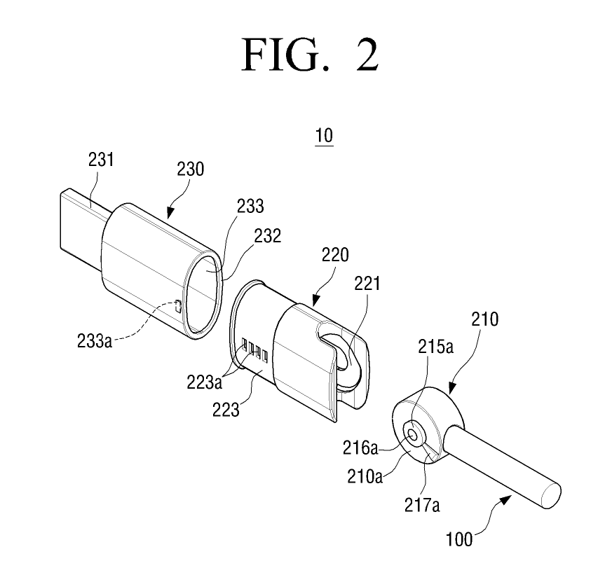

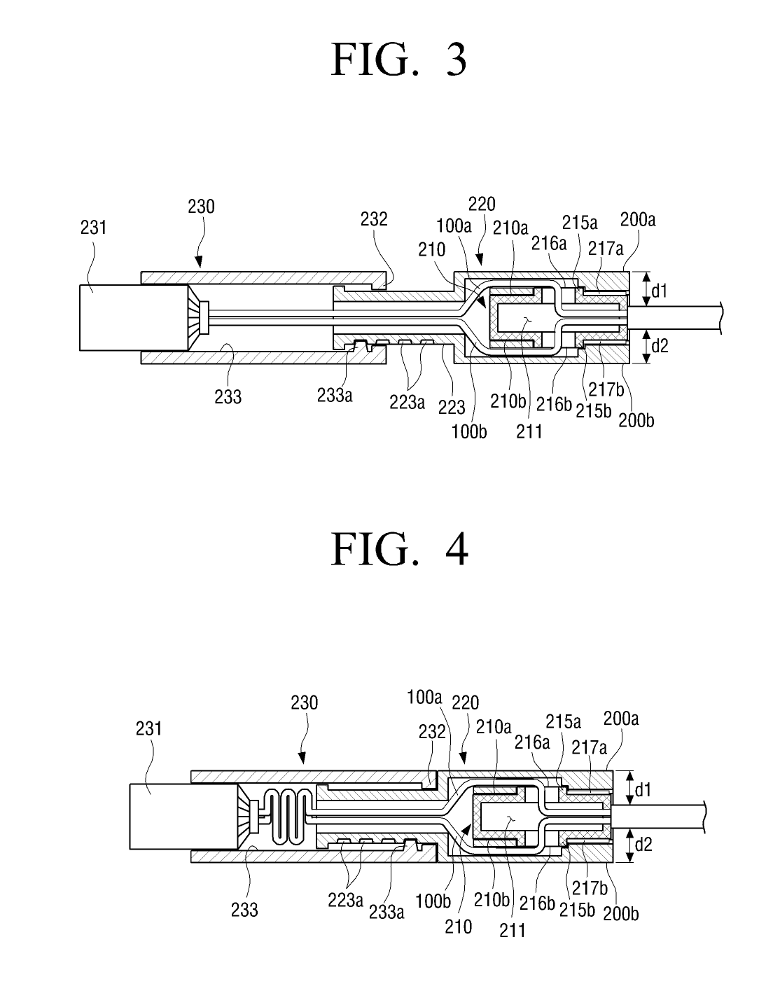

FIG. 1 is a schematic perspective view of a cable connector 10 according to an exemplary embodiment. FIG. 2 is an exploded perspective view of the cable connector 10 of FIG. 1. FIGS. 3 and 4 are cross-sectional views of the cable connector 10 of FIG. 1.

The cable connector 10 is used to transmit an electrical signal between two electronic devices. Examples of the cable connector 10 may include an HDMI cable connector, a USB cable connector, an audio cable connector, or a video cable connector.

At least one signal line 102 is formed within a sheath 101 of a cable 100. When the cable connector 10 is connected to two electronic devices, electrical signals are transmitted between the two electronic devices through the at least one signal line 102 formed within the cable 100.

A connector 200 is formed at a first end portion of the cable 100. Although not illustrated in FIGS. 1 and 2, another connector similar to the connector 200 shown in FIGS. 1 and 2 may also be formed at a second end portion of the cable 100. The connector 200 may be inserted into a terminal portion of an electronic device.

As shown in FIGS. 1 and 2, the connector 200 may include a rotation member 210, a main body 220, and a sub body 230.

The rotation member 210 is connected to the cable 100, and is rotatably connected to the main body 220. A rotation member mounting portion 221 on which the rotation member 210 is mounted is formed in the main body 220. As the rotation member 210 rotates, as indicated by an arrow A of FIG. 1, an angle between the connector 200 and the cable 100 may be adjusted. According to the present embodiment, the rotation member 210 may rotate by 180 degrees. However, it would be understood that a range of a rotation angle of the rotation member 210 may be changed.

Referring to FIGS. 3 and 4, a cavity 211 for providing a path of the cable 100 is formed in the rotation member 210. The cable 100 may be connected to a plug 231 of the sub body 230 through the rotation member 210 and the main body 220. For convenience of description, a portion of the cable 100, which is positioned in the connector 200 will be referred to as an internal cable. For clarity of illustration, any internal cable is not illustrated in FIG. 2.

A first rotation boss 215a is formed on an upper surface 210a of the rotation member 210, and a second rotation boss 215b is formed on a lower surface 210b of the rotation member 210. The first and second rotation bosses 215a and 215b are coaxially arranged with a rotation axis of the rotation member 210. The first and second rotation bosses 215a and 215b allow the rotation member 210 to rotate relative to the main body 220.

Referring to FIGS. 2 through 4, a first elastic protrusion 217a is formed on the upper surface 210a of the rotation member 210, and a second elastic protrusion 217b is formed on the lower surface 210b of the rotation member 210.

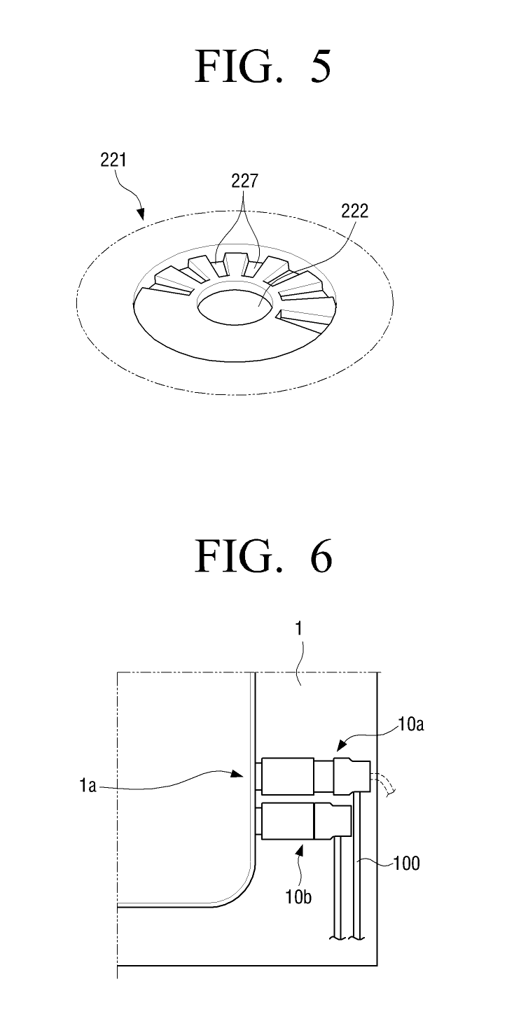

FIG. 5 is a perspective view of a magnified portion of the rotation member mounting portion 221 of FIG. 2. A slot 222 in which the first and second rotation bosses 215a and 215b of the rotation member 210 are installed is formed in the rotation member mounting portion 221. A plurality of grooves 227, to be engaged with the first and second elastic protrusions 217a and 217b, are formed in a contact surface of the rotation member mounting portion 221, which contacts the upper surface 210a or the lower surface 210b of the rotation member 210. FIG. 5 shows seven grooves 227 arranged at equal intervals of 30 degrees. When a user exerts a predetermined pressure on the rotation member 210, the first and second elastic protrusions 217a and 217b may separate from one groove 227 and then may become engaged with another groove 227. Thus, the user may control the rotation angle of the rotation member 210 with respect to the main body 220 through a number of steps equal to the number of grooves 227. It would be understood that the number of the grooves 227 and the angles between neighboring grooves 227 may be changed if necessary, and the angles between neighboring grooves 227 need not be equal.

According to the present embodiment, the first and second elastic protrusions 217a and 217b are formed on the rotation member 210, and the grooves 227 are formed in the main body 220. Alternatively, the first and second elastic protrusions 217a and 217b may be formed on the main body 220, and the grooves 227 may be formed in the rotation member 210. In addition, according to the present embodiment, the first and second elastic protrusions 217a and 217b are formed on the upper surface 210a and the lower surface 210b of the rotation member 210, respectively. Alternatively, an elastic protrusion may be formed on only the upper surface 210a or the lower surface 210b of the rotation member 210.

As shown in FIGS. 3 and 4, the cable 100 is divided into first and second internal cables 100a and 100b in the cavity 211 of the rotation member 210. The first internal cable 100a passes through a first opening 216a of the first rotation boss 215a, and the second internal cable 100b passes through a second opening 216b of the second rotation boss 215b. Thus, a distance d1 between an upper surface 200a of the connector 200 and the cable 100 may be equal to a distance d2 between a lower surface 200b of the connector 200 and the cable 100.

If the cable 100 is not divided and passes through only the first opening 216a of the first rotation boss 215a, the distance d1 between the upper surface 200a of the connector 200 and the cable 100 may be greater than the distance d2 between the lower surface 200b of the connector 200 and the cable 100 by as much as the diameter of the cable 100, which means that the cable 100 may be positioned to be asymmetrical with respect to the connector 200. In this case, if the cable connector 10 is configured so that the distance d1 between the upper surface 200a of the connector 200 and the cable 100 may be equal to the distance d2 between the lower surface 200b of the connector 200 and the cable 100, a thickness of the connector 200 may be increased unnecessarily. However, according to the present embodiment, since the cable 100 is divided into the first and second internal cables 100a and 100b in the cavity 211 of the rotation member 210, the cable 100 may be positioned to be symmetrical with the connector 200 without an unnecessary increase in the thickness of the connector 200. Alternately, of course, the cable may be undivided and may pass through only the second opening 216b of the second rotation boss 215b, and the distance d2 between the lower surface 200b of the connector 200 and the cable 100 may be greater than the distance d1 between the upper surface 200a of the connector 200 and the cable 100 by as much as the diameter of the cable 100.

The plug 231, which may be inserted into a terminal portion of an electronic device, is positioned at a first end portion of the sub body 230. The sub body 230 may be formed of extruded aluminum, thus providing an appealing external appearance of the connector 200 may and protecting components inside the sub body 230 from external shocks.

The sub body 230 may be moveable relative to the main body 220, as indicated by an arrow B of FIG. 1. As the sub body 230 is moved, the overall length of the connector 200 may be adjusted. FIG. 3 shows a case in which the sub body 230 is moved away from the main body 220 (that is, to the left, as shown in FIG. 3). FIG. 4 shows a case in which the sub body 230 is moved towards the main body 220 (that is, to the right, as shown in FIG. 4).

A separation blocking projection 232 is formed at a second end portion of the sub body 230. The separation blocking projection 232 prevents the sub body 230 from being separated from the main body 220.

An elastic protrusion 233a is formed on a contact surface 233 of the sub body 230, which contacts the main body 220. A plurality of grooves 233a, to be engaged with the elastic protrusion 233a, may be formed in a contact surface 223 of the main body 220, which contacts the sub body 230. When a user applies a predetermined pressure to the sub body 230, the elastic protrusion 233a may separate from one groove 223a, and then, may be engaged with another groove 223a. According to the present embodiment, since the number of the grooves 223a is four, the entire length of the connector 200 may be adjusted through four steps. However, it would be understood that the number and spacing of the grooves 223a may be changed in various ways.

In addition, according to the present embodiment, the elastic protrusion 233a is formed on the sub body 230, and the grooves 223a are formed in the main body 220. Alternatively, the elastic protrusion 233a may be formed on the main body 220, and the grooves 223a may be formed in the sub body 230.

As described above, the cable connector 10 may be advantageous in that the overall length of the connector 200, and the angle between the connector 200 and the cable 100 may be adjusted. With reference to FIG. 6, additional exemplary advantages of the cable connector 10 will be described in more detail.

FIG. 6 is a schematic plan view of a case in which two cable connectors 10a and 10b, which each correspond to the cable connector 10 of FIG. 1, are inserted into terminal portions 1a of a television 1, according to an exemplary embodiment. In general, the terminal portions 1a of the television 1 are disposed on a rear surface of the television 1. That is, the television 1 of FIG. 6 is viewed from the rear.

If the cable 100 of the cable connector 10a is thick, the flexibility of the cable 100 is reduced, the cable 100 may unnecessarily extend beyond a lateral surface of the television 1, as indicated by dotted lines, thereby adversely affecting an appearance of the television 1. In this case, a user may adjust a rotation angle of the rotation member 210 of the cable connector 10a so as to prevent the cable 100 from being unnecessarily exposed to a front surface of the television 1. In addition, if the cable connector 10a is positioned adjacent to the cable connector 10b, the cable connectors 10a and 10b may interfere with each other. In this case, the user may extend a length of the cable connector 10a so as to prevent the cable connectors 10a and 10b from interfering with each other.

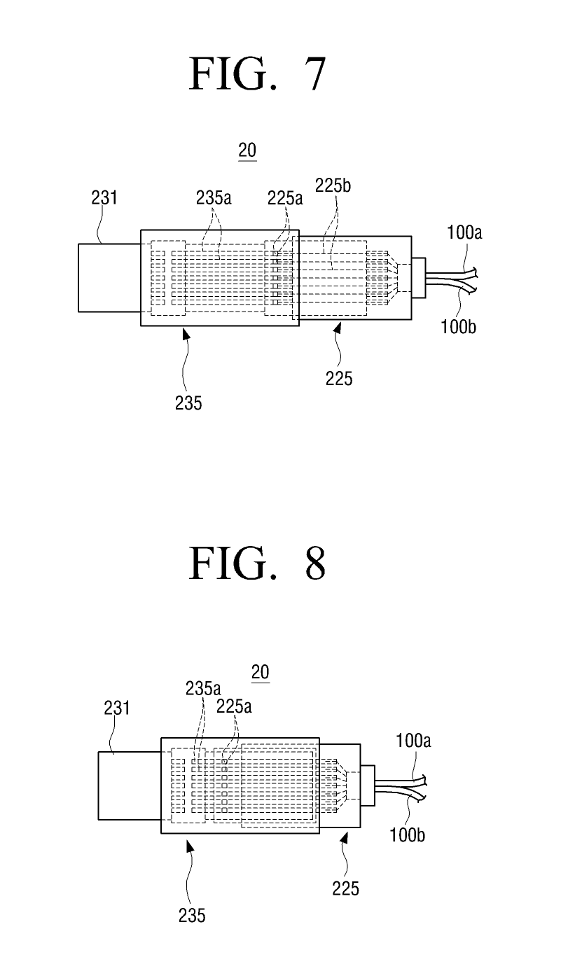

With reference to FIGS. 7 through 13, a cable connector 20 according to another exemplary embodiment will be described below. Components in FIGS. 7 through 13 having the same functions and operations as those in FIGS. 1 through 6 are denoted by the same reference numerals as those in FIGS. 1 through 6, and detailed descriptions thereof will not be given herein.

According to the above embodiment shown in FIGS. 3 and 4, the first and second internal cables 100a and 100b extend between the main body 220 and the sub body 230. However, according to the present embodiment, first and second internal connectors 225 and 235 are used so that the first and second internal cables 100a and 100b, and the plug 231 of the sub body 230 may be electrically connected to each other.

FIGS. 7 and 8 are schematic diagrams of the first and second internal connectors 225 and 235 when the sub body 230 is moved, according to another exemplary embodiment. FIG. 7 shows a case in which the second internal connector 235 is moved away from the first internal connector 225 (to the left, as shown in FIG. 7), which corresponds to FIG. 3. FIG. 8 shows a case in which the second internal connector is moved toward the first internal connector 225 (to the right, as shown in FIG. 8), which corresponds to FIG. 4.

The first internal connector 225 is formed in the main body 220. The second internal connector 235 is formed in the sub body 230. For clarity of illustration, in FIGS. 7 and 8, the main body 220 and the sub body 230 are not illustrated, but only the first and second internal connectors 225 and 235 are illustrated.

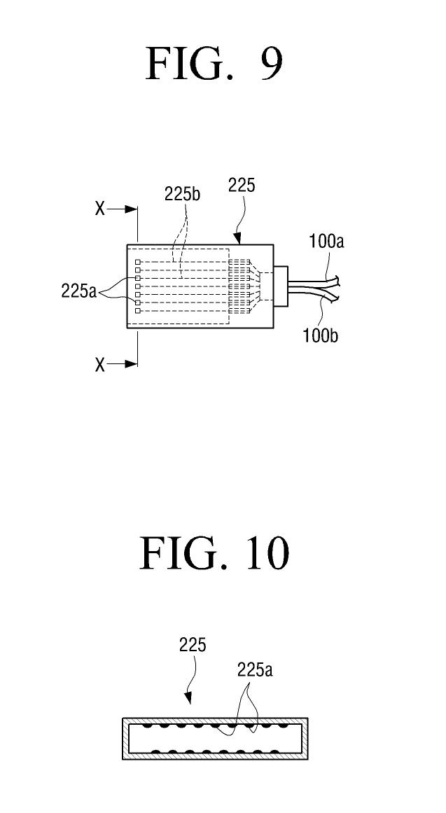

FIG. 9 is a schematic diagram of the first internal connector 225, according to another exemplary embodiment. FIG. 10 is a cross-sectional view of the first internal connector 225 taken along a line X-X of FIG. 9.

The first internal connector 225 is electrically connected to the first and second internal cables 100a and 100b, and is formed in the main body 220. A plurality of electrodes 225a, that are electrically connected to the first and second internal cables 100a and 100b, are formed in the first internal connector 225. A plurality of wires 225b electrically connect the first and second internal cables 100a and 100b to the electrodes 225a of the first internal connector 225.

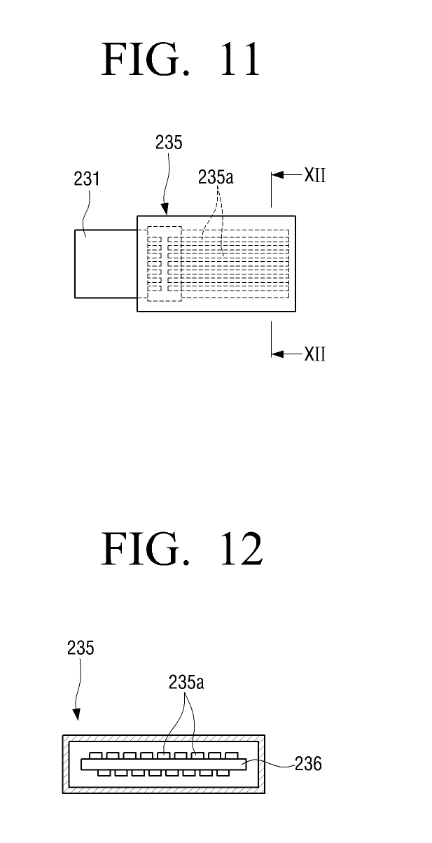

FIG. 11 is a schematic diagram of the second internal connector 235, according to another exemplary embodiment. FIG. 12 is a cross-sectional view of the second internal connector 235 taken along a line XII-XII of FIG. 11.

The second internal connector 235 is electrically connected to the first internal connector 225, and is formed in the sub body 230. As the sub body 230 is moved, the second internal connector 235 is moved. The second internal connector 235 includes a substrate 236 on which a plurality of electrodes 235a are formed. The electrodes 235 of the second internal connector 235 may extend in a longitudinal direction of the second internal connector 235, and may contact the electrodes 225a of the first internal connector 225. An entire length of the electrodes 235a of the second internal connector 235 may be equal to or greater than a distance by which the sub body 230 may move with respect to the main body.

The second internal connector 235 may be inserted into the first internal connector 225. That is, the second internal connector 235 may be a male connector, and the first internal connector 225 may be a female connector. However, it would be understood that the first internal connector 225 may be a male connector, and the second internal connector 235 may be a female connector.

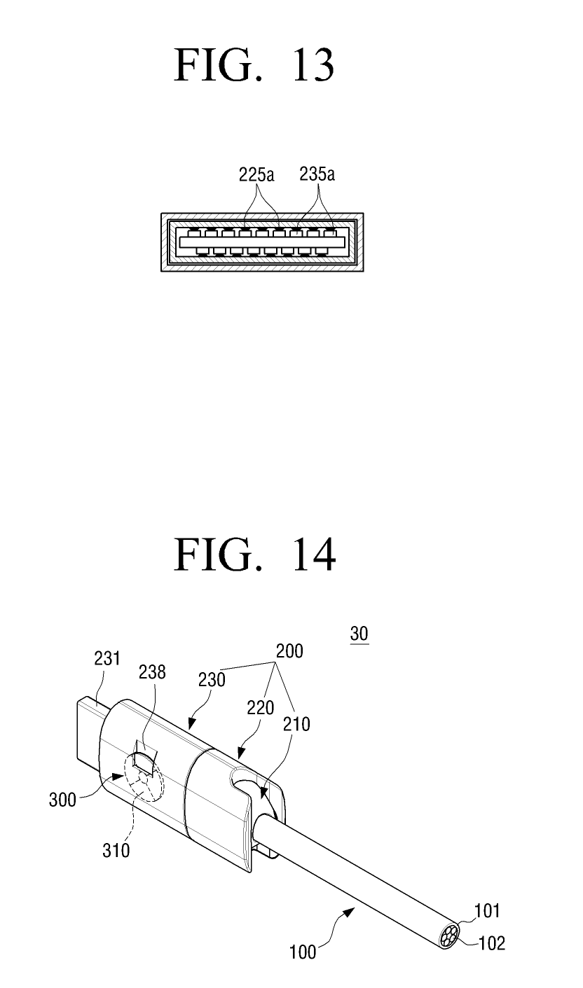

FIG. 13 is a cross-sectional view of a case in which the second internal connector 235 is inserted into the first internal connector 225, according to another exemplary embodiment. In this case, the electrodes 225 of the first internal connector 225 may contact the electrodes 235a of the second internal connector 235. Thus, the first and second internal cables 100a and 100b may be electrically connected to the plug 231 of the sub body 230 through the first and second internal connectors 225 and 235.

As shown in FIGS. 7 and 8, as the sub body 230 is moved, positions of the first and second internal connectors 225 and 235 relative to each other may be changed. As descried above, since the entire length of the electrodes 235a of the second internal connector 235 is equal to or greater than a distance through which the sub body 230 is moveable, although the relative positions of the first and second internal connectors 225 and 235 are changed, the first and second internal connectors 225 and 235 may remain electrically connected.

According to the present embodiment, the electrodes 235a of the second internal connector 235 extend in a longitudinal direction of the second internal connector 235. However, it would be understood that the electrodes 225a of the first internal connector 225 may extend in a longitudinal direction of the first internal connector 225.

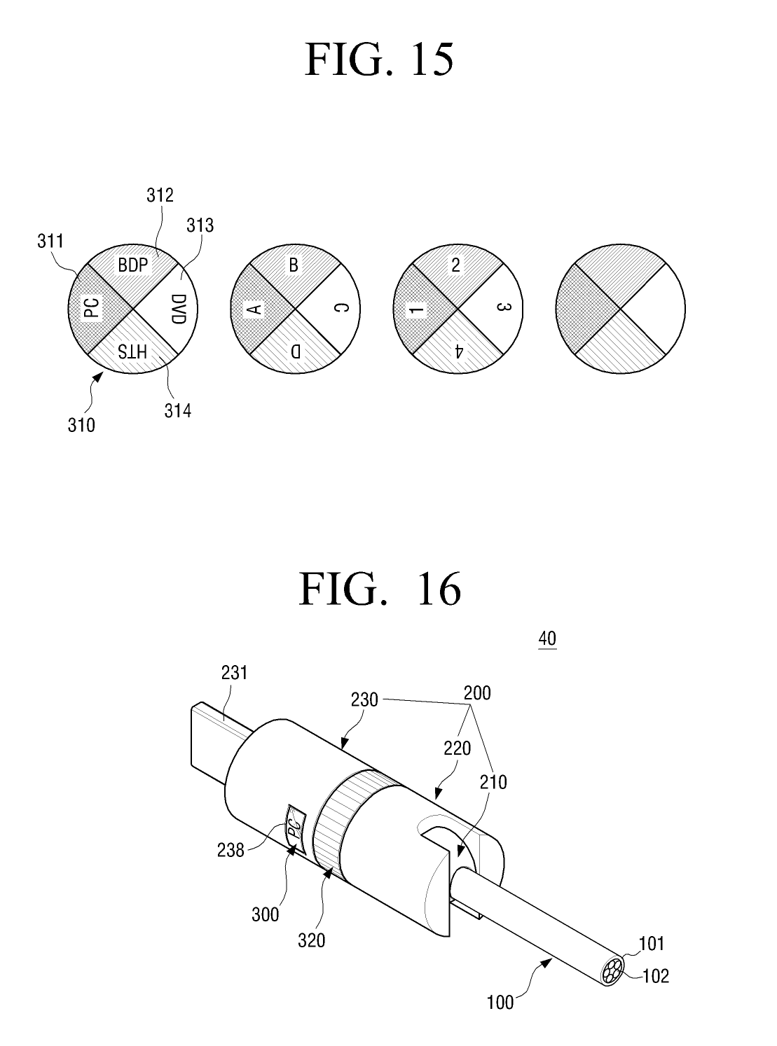

With reference to FIGS. 14 and 15, a cable connector 30 according to another exemplary embodiment will be described below. Components in FIGS. 14 and 15 having the same functions and operations as those in FIGS. 1 through 13 are denoted by the same reference numerals as those in FIGS. 1 through 13, and detailed descriptions thereof will not be given herein.

FIG. 14 is a schematic perspective view of the cable connector 30 according to another embodiment.

The cable connector 30 includes a mark unit 300. The mark unit 300 may display the type of the signal transmitted through the cable connector 30. Thus, a user may identify of use of the cable connector 30.

The mark unit 300 includes a circular member 310. The circular member 310 is rotatably installed on the sub body 230 of the connector 200. A window 238 for exposing a portion of the circular member 310 therethrough is formed in the sub body 230. A user may rotate the circular member 310 by turning an outer circumference surface of the circular member 310, which is exposed outside the window 238.

FIG. 15 is a set of diagrams of various examples of the circular member 310, according to exemplary embodiments. As shown in FIG. 15, the circular member 310 may be divided into four sections 311, 312, 313, and 314. The four sections 311, 312, 313, and 314 illustrate different colors or words, respectively. For example, the abbreviation “PC” (personal computer) may be marked on the first section 311 of the circular member 310, the abbreviation “BDP” (blue ray disk player) may be marked on the second section 312 of the circular member 310, the abbreviation “DVD” (digital versatile disk) may be marked on the third section 313 of the circular member 310, and the abbreviation “HTS” (home theater system) may be marked on the fourth section 314 of the circular member 310. As the circular member 310 rotates, only one of the four sections 311, 312, 313, and 314 is exposed at a time through the window 238 formed in the sub body 230.

A user may identify use of the cable connector 30 by turning the circular member 310. For example, when the cable connector 30 is connected to a personal computer, the user may turn the circular member 310 so as to show the first section 311 marked with the word “PC” through the window 238 of the sub body 230. Similarly, when the cable connector 30 is connected to a blue ray disc player, the user may turn the circular member 310 so as to show the second section 312 marked with the word “BDP” through the window 238 of the sub body 230. When the cable connector 30 is connected to a DVD player, the user may turn the circular member 310 so as to show the third section 313 marked with the word “DVD” through the window 238 of the sub body 230. In addition, when the cable connector 30 is connected to a home theater system, the user may turn the circular member 310 to show the fourth section 314 marked with the word “HTS” through the window 238 of the sub body 230. Thus, the user may easily identify use of the cable connector 30 by using the circular member 310.

Alternatively, characters such as “A”, “B”, “C”, and “D” or numbers such as “1”, “2”, “3”, and “4” may be marked on the first through fourth sections 311 through 314 of the circular member 310, respectively. Alternatively, the first through fourth sections 311 through 314 of the circular member 310 may be identified according to colors without characters or numbers.

According to the present embodiments, the circular member 310 is divided into the four sections 311 through 314. However, it would be understood that the circular member 310 may be divided into various numbers of sections. In addition, the circular member 310 may be mounted on the main body 220, but not on the sub body 230. It would be understood that a position where the circular member 310 is mounted may be changed in various ways.

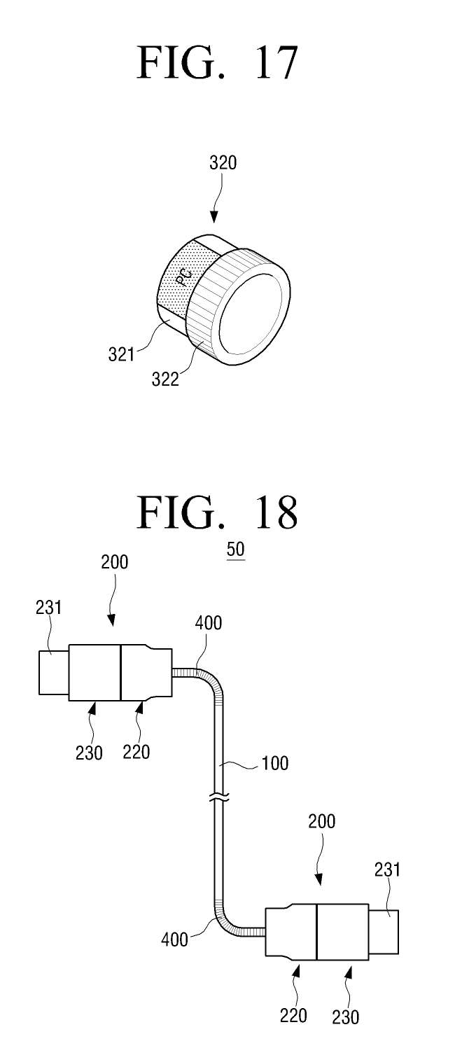

With reference to FIGS. 16 and 17, a cable connector 40 according to another exemplary embodiment will be described below. Components in FIGS. 16 and 17 having the same functions and operations as those in FIGS. 1 through 15 are denoted by the same reference numerals as those in FIGS. 1 through 15, and detailed descriptions thereof will not be given herein.

FIG. 16 is a schematic perspective view of the cable connector 40 according to another embodiment. FIG. 17 is a schematic perspective view of a ring member 320 of FIG. 16.

According to the present embodiment, the mark unit 300 includes the ring member 320. The ring member 320 is rotatably installed around the sub body 230 of the connector 200. As shown in FIG. 17, the ring member 320 includes a mark portion 321 and a grip portion 322.

The mark portion 321 is divided into a plurality of sections. The grip portion 322 is exposed to the outside. A user may grasp the grip portion 322 so as to turn the ring member 320.

Like in FIGS. 14 and 15, according to the present embodiment, the user may easily identify use of the cable connector 40 through a predetermined section of the mark portion 321, which is exposed through the window 238 formed in the sub body 230.

With reference to FIG. 18, a cable connector 50 according to another exemplary embodiment will be described below. Components in FIG. 18 having the same functions and operations as those in FIGS. 1 through 17 are denoted by the same reference numerals as those in FIGS. 1 through 17, and detailed descriptions thereof will not be given herein.

FIG. 18 is a schematic diagram of the cable connector 50 according to another embodiment.

Flexible coils 400 are formed as portions of the cable 100, which are adjacent to the connector 200. A user may easily change shapes of the flexible coils 400, and the changed shapes of the flexible coils 400 may be maintained. In FIG. 18, the flexible coils 400 are each bent to form an angle of 90 degrees. However, it would be understood that the shapes of the flexible coils 400 may be changed in various ways.

When the cable connector 50 is connected to a terminal portion of an electronic device, the user may change the shapes of the flexible coils 400 so as to prevent the cable connector 50 from interfering with another adjacent cable connector. Since shapes of portions of the cable 100, which are adjacent to the connector 200, may be changed by using the flexible coils 400, the connector 200 may not include the rotation member 210.

In order to prevent step differences between flexible coils 400 and the remaining portion of the cable 100 from resulting, a diameter of each of the flexible coils 400 may be equal to a diameter of the sheath 101 of the cable 100.

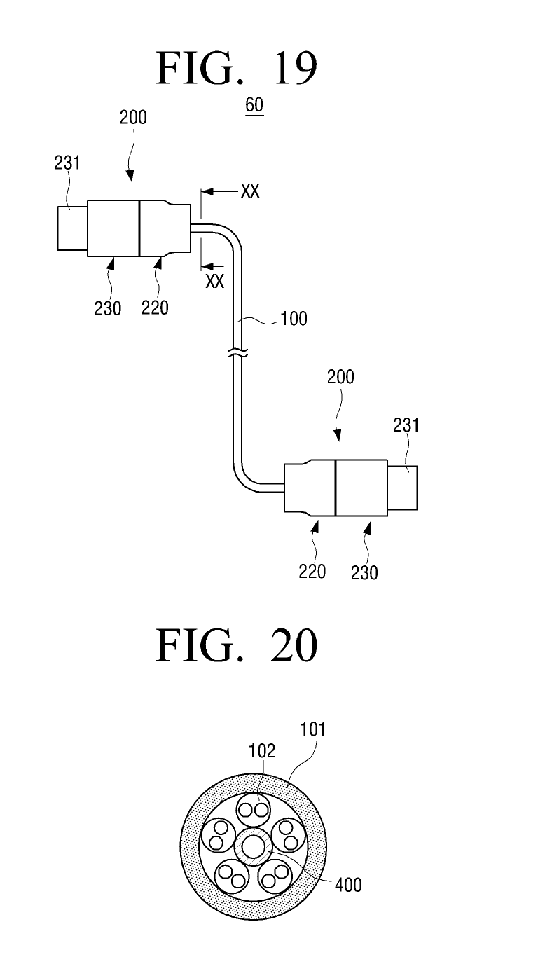

With reference to FIGS. 19 and 20, a cable connector 60 according to another exemplary embodiment will be described below. Components in FIGS. 19 and 20 having the same functions and operations as those in FIGS. 1 through 18 are denoted by the same reference numerals as those in FIGS. 1 through 18, and detailed descriptions thereof will not be given herein.

FIG. 19 a schematic diagram of the cable connector 60 according to another embodiment. FIG. 20 is a cross-sectional view of the cable connector 60 taken along a line XX-XX of FIG. 19.

As shown in FIG. 20, the flexible coils 400 are formed within the sheath 101 of the cable 100. Since the flexible coils 400 are not exposed to the outside, the cable 100 may have a uniform shape.

While exemplary embodiments have been particularly shown and described, it will be understood by those of ordinary skill in the art that various changes in form and details may be made therein without departing from the spirit and scope of the inventive concept as defined by the following claims.

What is claimed is:

1. A cable connector for transmitting a signal between first and second electronic devices, the cable connector comprising:
a cable comprising a sheath and at least one signal line disposed within the sheath; and
a connector disposed at an end portion of the cable,
wherein the connector comprises:
a rotation member connected to the cable;
a main body comprising a rotation member mounting portion to which the rotation member is rotatably connected; and
a sub body comprising a plug disposed at a first end portion of the sub body, wherein the sub body is moveably connected to the main body.

2. The cable connector of claim 1, wherein the sub body further comprises a separation blocking projection formed at a second end portion of the sub body, wherein the separation blocking projection prevents the sub body from being separated from the main body.

3. The cable connector of claim 1,
wherein the main body comprises a contact surface which contacts the sub body and the sub body comprises a contact surface which contacts the main body, and
the cable connector further comprises:
an elastic protrusion formed on a first one of the contact surface of the main body and the contact surface of the sub body; and
a plurality of grooves formed a second one of the contact surface of the main body and a contact surface of the sub body, wherein the each of the plurality of grooves is engageable with the elastic protrusion.

4. The cable connector of claim 1,
wherein the rotation member comprises a contact surface which contacts with the rotation member mounting portion and the rotation member mounting portion comprises a contact surface which contacts with the rotation member, and
the cable connector further comprises:
an elastic protrusion formed on a first one of the contact surface of the rotation member and a contact surface of the rotation member mounting portion; and
a plurality of grooves formed on a second one of the contact surface of the rotation member and a contact surface of the rotation member mounting portion, wherein each of the plurality of grooves is engageable with the elastic protrusion.

5. The cable connector of claim 1, wherein
the rotation member comprises a first rotation boss formed on an upper surface of the rotation member and a second rotation boss formed on a lower surface of the rotation member,
a portion the cable within the rotation member is divided into a first internal cable and a second internal cable,
the first internal cable extends through a first opening in the first rotation boss, and
the second internal cable extends through a second opening in the second rotation boss.

6. The cable connector of claim 1, wherein
the main body comprises a first internal connector that is electrically connected to the cable, and
the sub body comprises a second internal connector that is electrically connected to the first internal connector.

7. The cable connector of claim 6, wherein
the first internal connector comprises a plurality of first electrodes,
the second internal connector comprises a plurality of second electrodes that are electrically connected to the plurality of first electrodes, and
a length of each of the plurality of first electrodes or a length of each of the plurality of second electrodes is equal to or greater than a distance through which the sub body is movable with respect to the main body.

8. The cable connector of claim 6, wherein one of the first and second internal connectors is a male connector, and the other one of the first and second internal connectors is a female connector.

9. The cable connector of claim 1, further comprising a mark unit for indicating a use of the cable connector.

10. The cable connector of claim 9, wherein
the mark unit comprises a circular member that is rotatably mounted to one of the main body and the sub body,
the circular member comprises a plurality of sections, and
the connector further comprises a window formed in the one of the main body and the sub body to which the circular member is rotatably mounted through which one of the plurality of sections of the circular member is visible.

11. The cable connector of claim 10, wherein each of the plurality of sections of the circular member is marked with a different color or a different character.

12. The cable connector of claim 9,
the mark unit comprises a ring member that is rotatably mounted to one of the main body and the sub body, the ring member comprises a mark portion that comprises a plurality of sections and a grip portion which is exposed to an outside of the connector, and
the connector further comprises a window formed in the one of the main body and the sub body to which the ring member is rotatably mounted through which one of the plurality of sections of the mark portion is visible.

13. The cable connector of claim 12, wherein each of the plurality of sections of the mark portion is marked with a different color or a different character.

14. The cable connector of claim 1, wherein the cable comprises a flexible coil adjacent to the connector.

15. The cable connector of claim 14, wherein
the flexible coil is exposed outside the connector, and
a diameter of the flexible coil is equal to a diameter of the sheath of the cable.

16. The cable connector of claim 14, wherein the flexible coil is disposed within the sheath of the cable.

17. The cable connector of claim 1, wherein the sub body is formed of extruded aluminum.

18. A cable connector comprising:
a cable comprising at least one signal line; and
a connector disposed at an end portion of the cable, wherein the connector comprises:
at least one body,
a mark unit which is rotatably mounted to the at least one body and which comprises an indicator comprising a plurality of sections, and
a window formed in the body through which one of the plurality of sections of the mark unit is visible.

19. The cable connector of claim 18, wherein each of the plurality of sections of the indicator comprises a different color or a different character.

20. A cable connector comprising:
a cable;
a main body;
a rotation member fixedly connected to an end of the cable and rotatably connected to a first end of the main body;
a sub body moveably connected to a second end of the main body.
